(19) United States
(12) Patent Application Publication
(10) Pub. No.: US 2008/0207175 A1
(43) Pub. Date: Aug. 28, 2008

(54) Communication notification setting method

(75) Inventor: Chen-Yu Wang, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION, Taipei (TW)

(21) Appl. No.: 11/710,952

(22) Filed: Feb. 27, 2007

(51) Int. Cl. H04M 3/42

(52) U.S. Cl. 455/412.2

(57) ABSTRACT

A communication notification setting method applied to a communication device having at least one multimedia file includes the following steps. First, a notification setting command received so as to, in response, display a communication prompt setting frame, which includes a file selecting field and a play parameter selecting field. Then, the multimedia file is selected and loaded via the file selecting field. A play parameter is received and set through the play parameter selecting field to calculate a playable segment of the multimedia file. The play parameter is then stored. Finally, the playable segment of the multimedia file is played according to the stored play parameter when the communication device receives a communication message.

### BACKGROUND OF THE INVENTION

1. Field of Invention

The invention relates to a setting method, and, in particular, to a communication notification setting method.

2. Related Art

With the development of technology and the enhancement of the quality of human life, the demands on product quality and human-oriented function have greatly increased. Of course, there is no exception to the demands on communication devices. Communication devices are required to have an increasing communication quality and a growing array of human-oriented functions, such as hands-free function or customizable incoming call notifications including incoming call music and incoming call ring tones. Referring to FIG. 1, a conventional communication device 1 includes a register 11, a playing module 12 and a storing module 13. The register 11 is electrically connected to the playing module 12 and the storing module 13. Typically, the user can download many music files M1 according to his/her personal requirements, store the music files in the storing module 13 of the communication device 1, and select a specific music file M1 as the incoming call notification. When the communication device 1 receives a incoming call message, the storing module 13 of the communication device 1 outputs the music file M1 to the register 11 such that the playing module 12 can play the whole music file M1 repeatedly until the user answers the call. However, different users may have different preferences. For example, some users hope that the playing module 12 of the communication device 1 only repeatedly plays the accessory theme of the music file M1 but not the whole music file M1 when the communication device 1 receives the incoming call message. So, the manufacturer usually adds a editing module 14 to the communication device 1, as shown in FIG. 2, wherein the editing module 14 cuts the music file M1 in the storing module 13 to generate a fragment music file M2, which may be considered an accessory theme, and the storing module 13 stores the fragment music file M2. Thus, when the communication device I receives the incoming call message, the storing module 13 of the communication device 1 outputs the fragment music file M2 to the register 11 such that the playing module 12 plays the fragment music file M2.

In other words, the storing module 13 has to store not only many music files M1 but also the fragment music file M2. However, if the user produces more fragment music files M2, the storing module 13 has to provide a larger storage capacity for storing the fragment music files M2, and the manufacturer has to increase the storage capacity of the storing module 13 in order to satisfy the requirements of the user, thereby increasing the selling price of the product.

Thus, it is an important subject of the invention to provide a communication notification setting method capable of solving the above-mentioned problems.

### SUMMARY OF THE INVENTION

In view of the foregoing, the invention is to provide a communication notification setting method, which can generate a musical fragment without saving it into additional file via editing. Thus, this musical fragment of a multimedia file will be played when a communication device receives a communication message.

To achieve the above, the invention discloses a communication notification setting method applied to a communication device having at least one multimedia file. The communication notification setting method includes the following steps. First, a notification setting command is received to display a communication prompt setting frame, which includes a file selecting field and a play parameter selecting field. Then, the multimedia file is selected and loaded through the file selecting field, and a play parameter is received and set through the play parameter selecting field to calculate a playable segment of the multimedia file. The play parameter is then stored. Finally, the playable segment of the multimedia file is played according to the stored play parameter when the communication device receives a communication message.

As mentioned hereinabove, the communication notification setting method of the invention enables the user to set the play parameter to calculate the playable segment of the multimedia file, and to store the set play parameter into a storing module. So, the communication device can play the playable segment of the multimedia file according to the play parameter. In other words, the invention only has to store much smaller data quantity of the play parameter, and does not have to store the entire fragment music file. Compared with the prior art, the same user requirements can be satisfied with a smaller storage capacity of the storing module of the invention, and the manufacturing cost of the product can thus be reduced.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional communication device;

FIG. 2 is a schematic illustration showing another conventional communication device;

FIG. 3 is a schematic illustration showing a flow chart of a communication notification setting method according to a preferred embodiment of the invention;

FIG. 4 is a schematic illustration showing a communication device using the communication notification setting method according to the preferred embodiment of the invention;

FIGS. 5, 7, 8, 9, 10 and 11 are a set of schematic illustrations showing communication prompt setting frames displayed according to the communication notification setting method of FIG. 3;

FIG. 6 is a schematic illustration showing details of step S30 in the communication notification setting method of FIG. 3;

FIG. 12 is a schematic illustration showing another communication device using the communication notification setting method according to the preferred embodiment of the invention; and

FIGS. 13 to 17 are another set of schematic illustrations showing communication prompt setting frames displayed according to the communication notification setting method of FIG. 11.

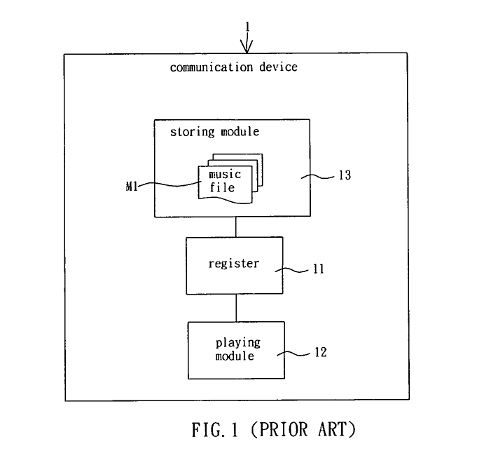

### DETAILED DESCRIPTION OF THE INVENTION

The present invention will be apparent from the following detailed description, which proceeds with reference to the accompanying drawings, wherein the same references relate to the same elements.

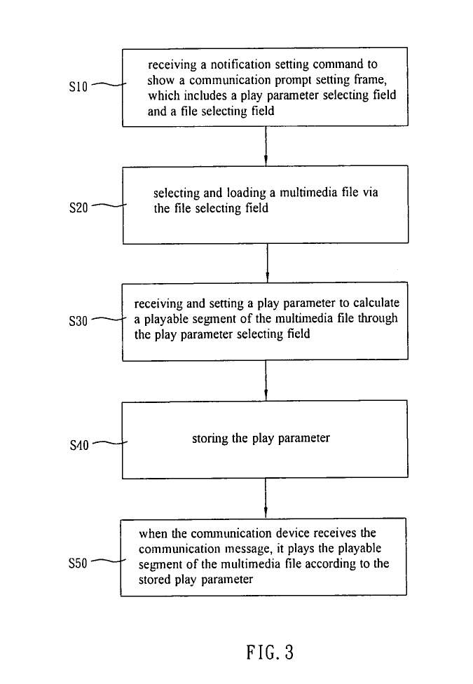

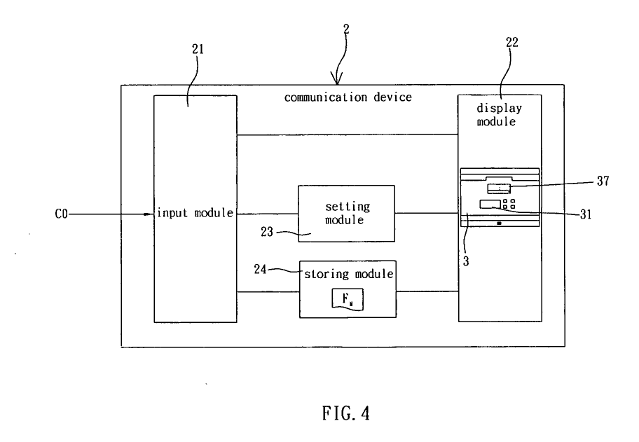

As shown in FIGS. 3 and 4, the communication notification setting method according to the preferred embodiment of the invention is applied to a communication device 2, which includes an input module 21, a display module 22, a setting module 23 and a storing module 24 for storing at least one multimedia file FM. In this embodiment, the communication device 2 may be a mobile phone, such as a smart mobile phone. The communication notification setting method includes steps S10 to S50.

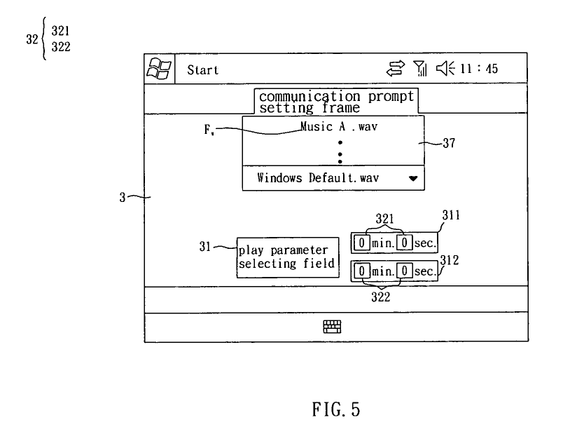

As shown in FIG. 3, step S10 receives a notification setting command to display a communication prompt setting frame, which includes a play parameter selecting field and a file selecting field. In this embodiment, as shown in FIGS. 4 and 5, the input module 21, such as a keyboard, a button or a touch panel, receives at least one notification setting command C0, and the notification setting command C0 may include a character message or a click message. For example, the user may input digits (character message) through the keyboard, or click a specific option (click message) to make the subsequent setting via the touch panel.

The display module 22 displays a communication prompt setting frame 3 and displays a thumbnail image (not shown) of the communication prompt setting frame. At this time, the user may click the thumbnail image of the communication prompt setting frame through the input module 21 to transmit the notification setting command C0 to the display module 22, and the display module 22 receives the notification setting command C0 and displays the communication prompt setting frame 3.

As shown in FIG. 3, step S20 selects and loads the multimedia file via the file selecting field. In this embodiment, as shown in FIGS. 4 and 5, the setting module 23 may receive a select command (not shown) to select the multimedia file FM from the storing module 24.

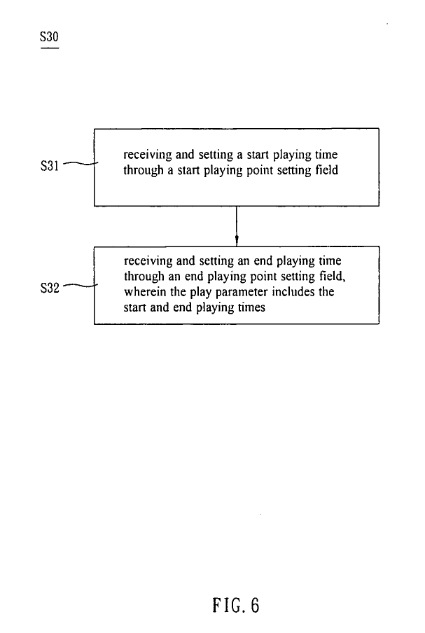

As shown in FIG. 3, step S30 receives and sets a play parameter to calculate a playable segment of the multimedia file through the play parameter selecting field. In this embodiment, as shown in FIGS. 4 and 5, the setting module 23 receives and sets a play parameter 32 through a play parameter selecting field 31 to calculate the playable segment of the multimedia file FM to be used as a communication notification, which may be a incoming call ring tone, incoming call music, a text message ring tone or text message music. In addition, the play parameter 32 may include a start playing time 321 and an end playing time 322. For example, if the total length of the multimedia file FM is two minutes, the start playing time 321 may range from 0 to 2 minutes, and the end playing time 322 may range from the start playing time 321 to two minutes. Step S30 may include steps S31 to S32, as shown in FIG. 6.

Referring to FIG. 6, step S31 receives and sets a start playing time through a start playing point setting field.

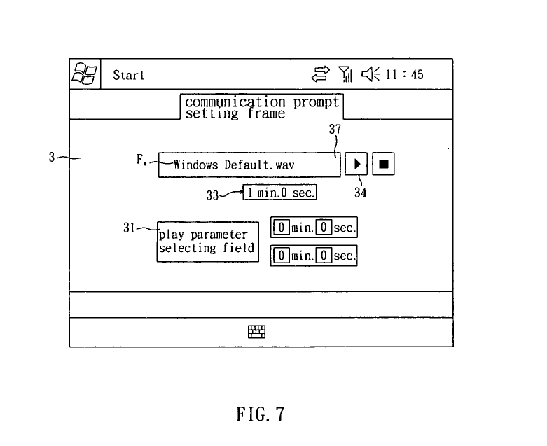

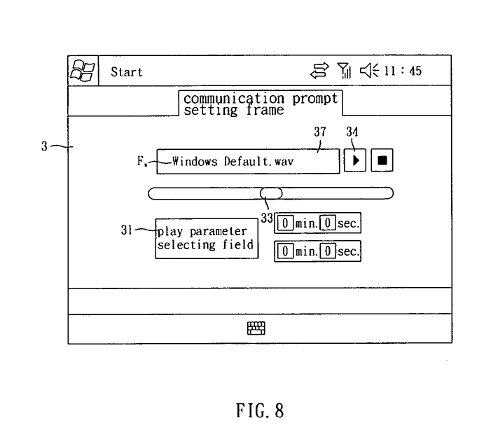

Step S32 receives and sets an end playing time through an end playing point setting field. In this embodiment, as shown in FIGS. 4 to 5, the setting module 23 receives and sets the start playing time 321 through a start playing point setting field 311, and receives and sets the end playing time 322 through an end playing point setting field 312. Furthermore, referring to FIG. 7, the communication prompt setting frame 3 further synchronously displays a real-time play time 33 for pre-play of the multimedia file FM, wherein the real-time play time 33 represents the pre-play progress of the multimedia file FM. For example, the user may click a pre-play key option 34 to pre-play the multimedia file FM, wherein the total length of the multimedia file FM is two minutes. When the pre-played progress is one half, the real-time play time 33 is displayed as “1 minute and 0 seconds”. In addition, the communication prompt setting frame 3 may display the real-time play time 33 as text or patterns. As shown in FIG. 7, the communication prompt setting frame 3 displays the real-time play time 33 as text. As shown in FIG. 8, the communication prompt setting frame 3 displays the real-time play time 33 as a pattern such as a program bar. Thus, the user may listen to the pre-play multimedia file FM and set the play parameter 32 subsequently according to the real-time play time 33.

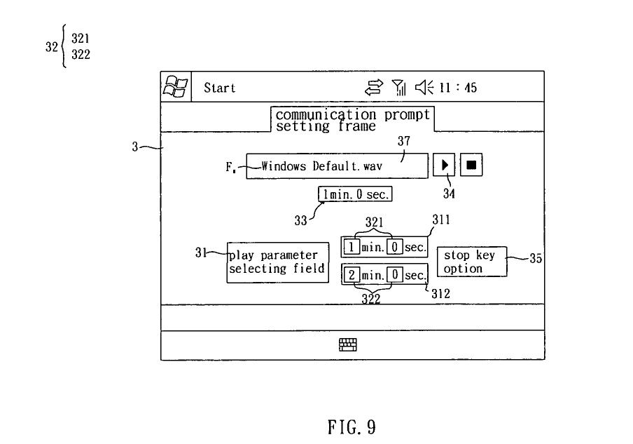

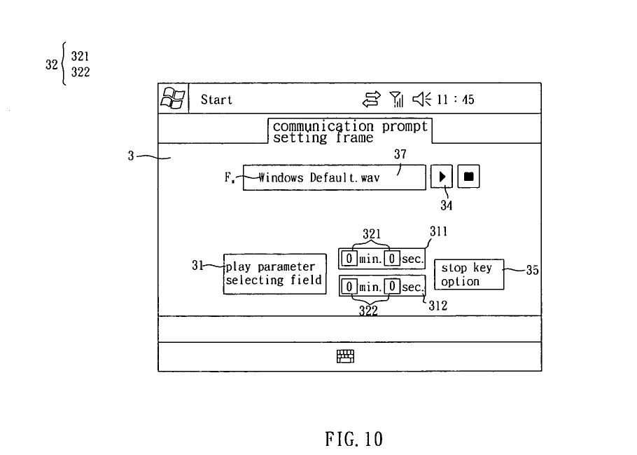

As shown in FIGS. 4 to 9, the communication prompt setting frame 3 further includes a stop key option 35. When the user clicks the stop key option 35, the setting module 23 stops the real-time play time 33 to obtain the start playing time 321, or stops the real-time play time 33 to obtain the end playing time 322. For example, if the total length of the communication notification is two minutes, the real-time play time 33 is displayed as “1 minute and 0 seconds” when the communication notification has been pre-played halfway through. At this moment, when the user clicks the stop key option 35, the setting module 23 stops the real-time play time 33 at “1 minute and 0 seconds”, obtains the value of “1 minute and 0 seconds” and inputs the value to the start playing point setting field 311 as the start playing time 321. Then, the user can click the pre-play key option 34 to continue pre-playing the multimedia file FM to the end, and then click the stop key option 35. At this moment, the setting module 23 stops the real-time play time 33 at “2 minutes and 0 seconds”, obtains the value of “2 minutes and 0 seconds”, and inputs the value to the end playing point setting field 312 as the end playing time 322. Of course, as shown in FIGS. 4 and 10, the real-time play time 33 may also be located in the start playing point setting field 311 or the end playing point setting field 312. In this case, when the user clicks the stop key option 35, the setting module 23 stops the real-time play time 33 in the start playing point setting field 311, and the stopped real-time play time 33 serves as the start playing time (not shown in FIG. 10), or the setting module 23 stops the real-time play time 33 in the end playing point setting field 312, and the stopped real-time play time 33 serves as the end playing time (not shown in FIG. 10).

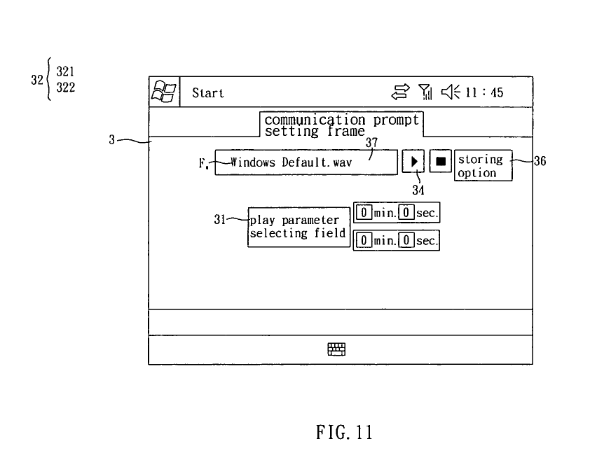

As shown in FIG. 3, step S40 is performed after step S30 to store the play parameter 32. In this embodiment, as shown in FIGS. 4 and 11, the communication prompt setting frame 3 may further include a storing option 36. Thus, the user may click the storing option 36 to enable the storing module 24 to store the play parameter 32.

As shown in FIGS. 3 and 4, step S50 enables the communication device 2 to play the playable segment of the multimedia file FM according to the stored play parameter 32 when the communication device 2 receives the communication message. For example, if the start playing time 321 of the play parameter 32 is “1 minute and 0 seconds”, and the end playing time 322 of the play parameter 32 is “2 minutes and 0 seconds”, the playable segment represents the multimedia file FM ranging form “1 minute and 0 seconds” to “2 minutes and 0 seconds”. In addition, the communication message may be an incoming call message or text message.

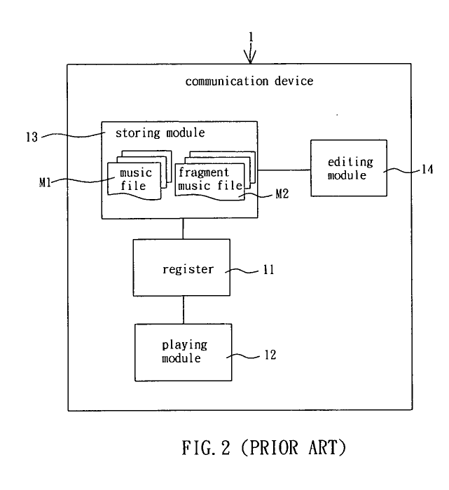

As mentioned hereinabove, the communication device 2 enables the user to set the play parameter 32 of the multimedia file FM by himself or herself, and to store the set play parameter 32 into the storing module 24. So, the communication device 2 can play the playable segment of the multimedia file FM according to the play parameter 32. In other words, the communication device 2 of the invention only has to store the smaller data quantity of the play parameter 32 but not the entire, much larger data quantity of the fragment music file M2, as shown in FIG. 2. Compared with the prior art, the storing module 24 of the invention can satisfy the same user requirements with a smaller storage capacity thus decreasing the manufacturing cost of the product.

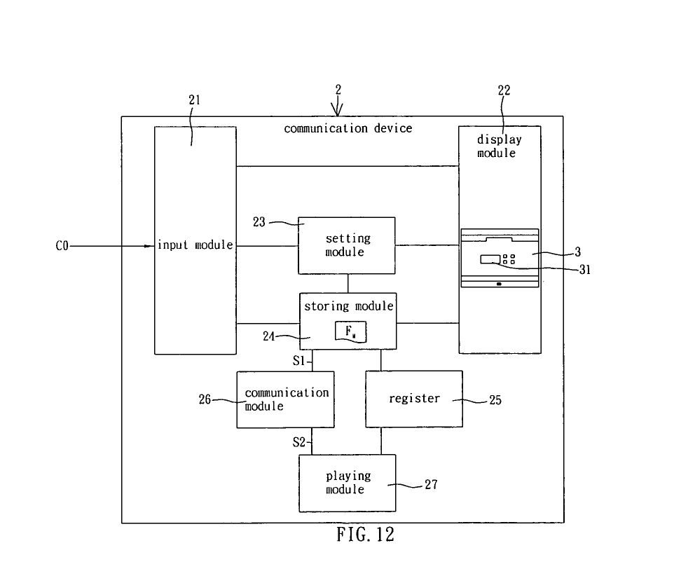

In order to make the invention more comprehensive, an example will be illustrated hereinafter to explain the communication device 2. Referring to FIG. 12, the communication device 2 further includes a register 25, a communication module 26 and a playing module 27. The register 25 is electrically connected to the storing module 24 and the playing module 27, and the communication module 26 is electrically connected to the storing module 24 and the playing module 27. The communication module 26 may be a GSM module or a PHS module, and the playing module 27 may be a speaker or an earphone.

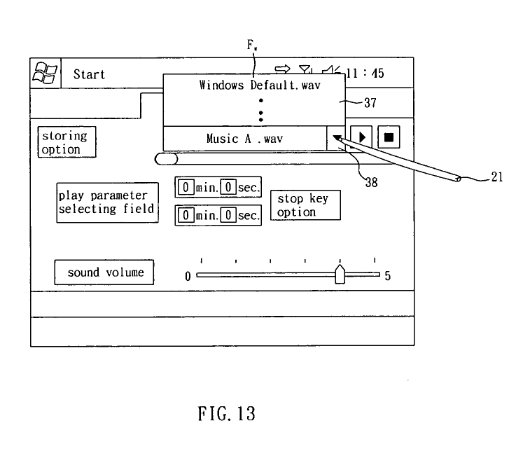

First, as shown in FIG. 12, the display module 22 may display a thumbnail image (not shown) of the communication prompt setting frame, and the user may click the thumbnail image of the communication prompt setting frame through the input module 21 to display the communication prompt setting frame 3, as shown in FIG. 13.

Next, as shown in FIGS. 12 and 13, the user may click a list key option 38 through the input module 21 to display a file selecting field 37, and then select his/her desired multimedia file FM from the multimedia files in the file selecting field 37.

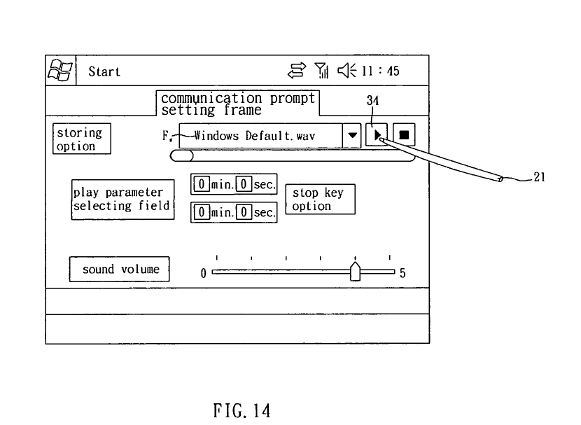

Then, as shown in FIGS. 12 and 14, the user clicks the pre-play key option 34 to pre-play the multimedia file FM through the input module 21. At this moment, the real-time play time 33 is located in the start playing point setting field 311 and is changed as the proceeding pre-play progress.

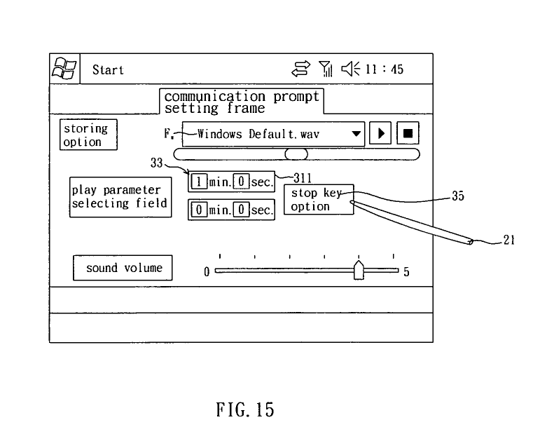

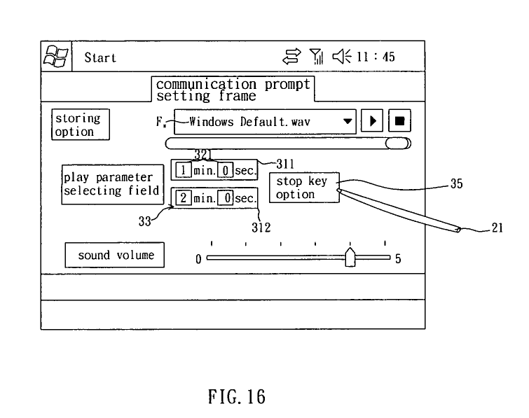

Next, as shown in FIGS. 12 and 15, the setting module 23 stops the real-time play time 33 in the start playing point setting field 311 at “1 minute and 0 seconds” serving as the start playing time 321 (see FIG. 16) when the user clicks the stop key option 35.

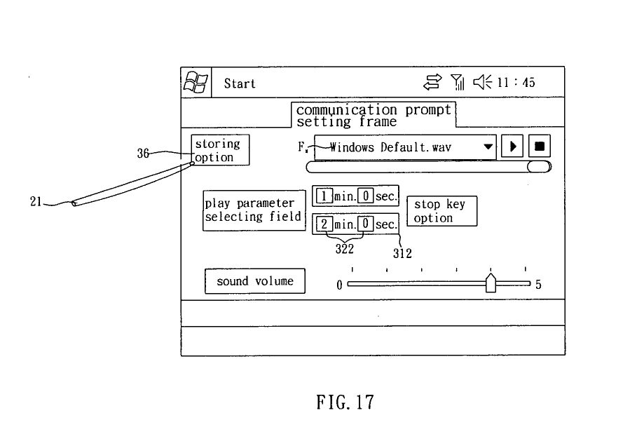

Then, as shown in FIGS. 12 and 16, the start playing time 321 in the start playing point setting field 311 is set, and then the real-time play time 33 is located in the start playing point setting field 311 until the user again clicks the stop key option 35. This time, when the user clicks the stop key option 35, the setting module 23 stops the real-time play time 33 in the end playing point setting field 312 at “2 minutes and 0 seconds” as the end playing time 322 (see FIG. 17).

Finally, as shown in FIGS. 12 and 17, the user may adjust the volume of the multimedia file FM. After the above-mentioned setting is completed, the user may click the storing option 36 to store the play parameter 32 through the input module 21.

Now that the setting is complete, when the communication module 26 of the communication device 2 receives the communication message, the communication module 26 outputs control signals S1 and S2 to the storing module 24 and the playing module 27, respectively. The storing module 24 outputs the play parameter 32 to the register 25 according to the control signal S1, and the playing module 27 receives the control signal S2 to play the playable segment of the multimedia file FM selected according to the play parameter 32.

In summary, the communication notification setting method of the invention enables the user to set the play parameter to calculate the playable segment of the multimedia file, and to store the set play parameter into the storing module. Thus, the communication device can play the playable segment of the multimedia file according to the play parameter. In other words, the invention only has to store much smaller data quantity of the play parameter, and does not have to store the entire fragment music file. Compared with the prior art, the same user requirements can be satisfied with a smaller storage capacity of the storing module of the invention, and the manufacturing cost of the product can thus be reduced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A communication notification setting method applied to a communication device having at least one multimedia file, the method comprising the steps of:
receiving a notification setting command to display a communication prompt setting frame, which comprises a file selecting field and a play parameter selecting field;
selecting and loading the multimedia file through the file selecting field;
receiving and setting a play parameter through the play parameter selecting field to calculate a playable segment of the multimedia file;
storing the play parameter; and
playing the playable segment of the multimedia file according to the stored play parameter when the communication device receives a communication message.

2. The method according to claim 1, wherein the communication message is an incoming call message or a text message.

3. The method according to claim 1, wherein the play parameter selecting field comprises a start playing point setting field and an end playing point setting field, and the step of receiving and setting the play parameter through the play parameter selecting field comprises:
receiving and setting a start playing time through the start playing point setting field; and
receiving and setting an end playing time through the end playing point setting field, wherein the play parameter comprises the start playing time and the end playing time.

4. The method according to claim 3, wherein the step of receiving and setting the play parameter through the play parameter selecting field further comprises:
enabling the communication prompt setting frame to synchronously display a real-time play time of the pre-play of the multimedia file.

5. The method according to claim 4, wherein the communication prompt setting frame further displays at least one stop key option, and when the stop key option is clicked, the real-time play time is stopped so as to receive and set the start playing time via the start playing point setting field in the step of receiving and setting the start playing time via the start playing point setting field.

6. The method according to claim 4, wherein the communication prompt setting frame further displays at least one stop key option, and when the stop key option is clicked, the real-time play time is stopped so as to receive and set the end playing time via the end playing point setting field in the step of receiving and setting the end playing time via the end playing point setting field.
